(19) United States
(12) Patent Application Publication
(10) Pub. No.: US 2008/0112167 A1
(43) Pub. Date: May 15, 2008

(54) Ornaments having swingable shining pieces

(76) Inventor: Hung-Huei Chung, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/599,314

(22) Filed: Nov. 15, 2006

(51) Int. Cl. F21V 7/00

(52) U.S. Cl. 362/247

(57) ABSTRACT

The invention relates to an ornament having swingable shining pieces, which includes a lot of bulbs on the ornament. A lot of shining pieces including reflective plane are also provided on the ornament. Hence, the bulbs and the swingable pieces can emit rays outward at the same time that obtains a perfect decorative shining effect without increasing use of bulbs.

### BACKGROUND OF THE INVENTION

In order to provide a shining decorative effect, some patterned ornaments are provided, for example shown in FIGS. 1 and 2, wherein bulbs (2) are directly mounted thereon. The bulbs (2) on the ornament (1) can emit rays outward to display the outlook of the patterned configuration. It reaches a simple decorative purpose, especially at night. But in this conventional design, if the bulbs (2) are not enough, the lighting effect of the patterned decoration will be poor. If more bulbs (2) are provided, the cost will be high and it increases the total weight that is a burden to the patterned ornament. Further, power supplier will become another problem.

### SUMMARY OF THE INVENTION

It is an object of the present invention to provide an improved decorative design of patterned ornaments to overcome the drawback of prior arts, which includes a lot of shining pieces mounted on the patterned ornaments and obtains a perfect lighting effect. Now, accompanying with the following drawings, the character of the present invention will be described here and after.

### BRIEF DESCRIPTION OF THE DRAWINGS

FIG. 1 is a perspective view showing a conventional patterned ornament connecting with bulbs thereon.

FIG. 2 is a plan view of FIG. 1.

FIG. 3 is a perspective view showing a patterned ornament having swingable shining pieces according to the present invention.

FIG. 4 is a plan view of FIG. 3 showing cross-sectional views of shining pieces.

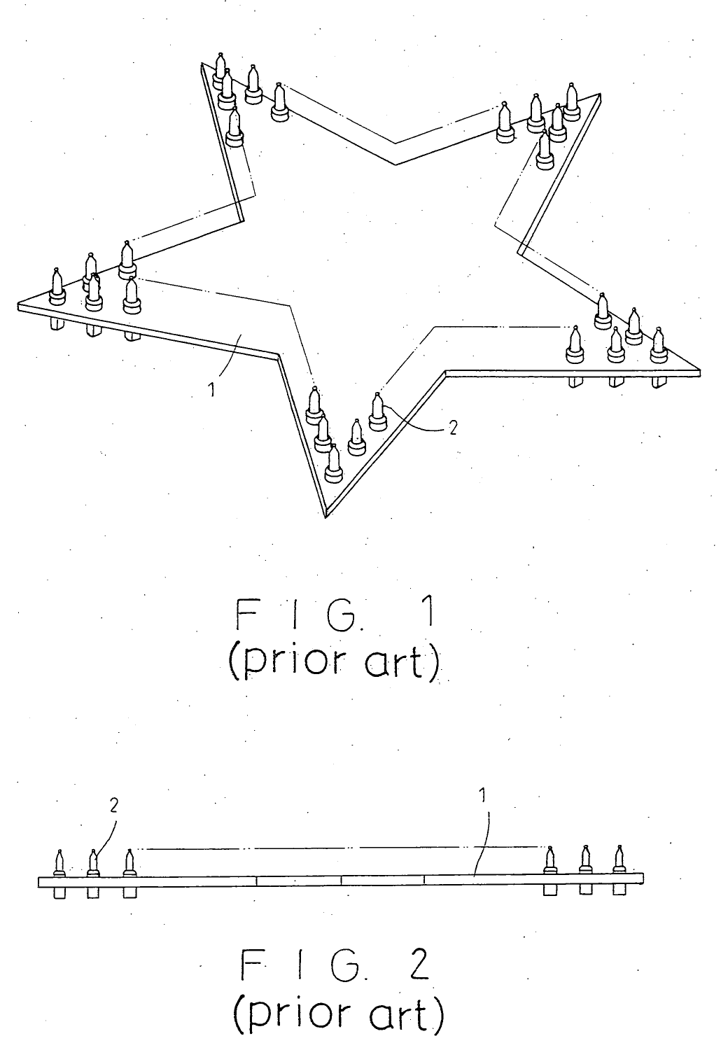

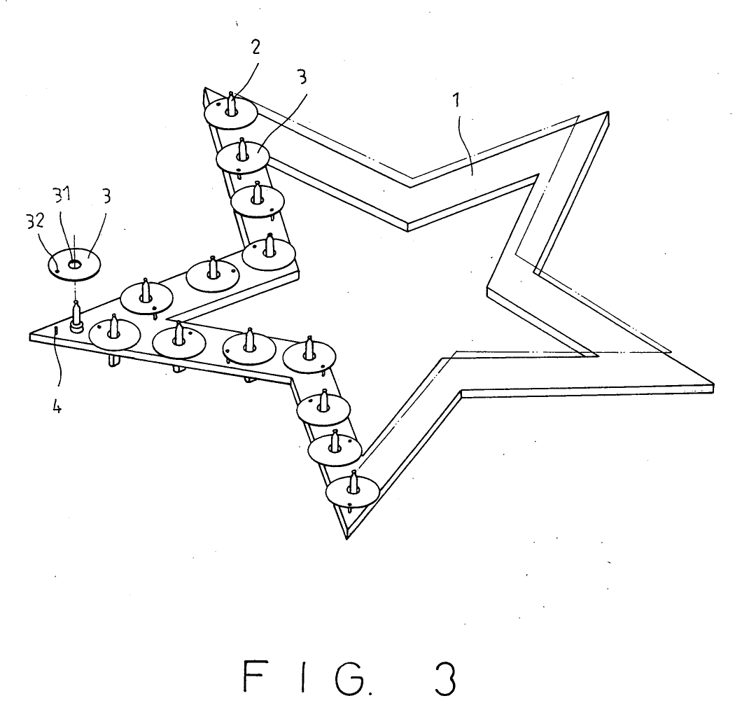

### DETAILED DESCRIPTION OF THE PREFERRED EMBODIMENT

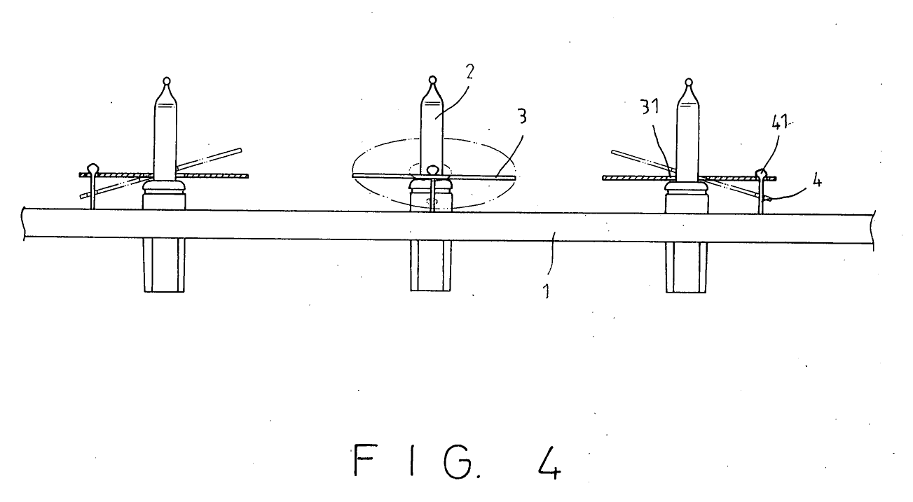

Referring to FIGS. 3 and 4, the present invention relates to a patterned ornament having swingable shining pieces, wherein the ornament can be designed to have any suitable outlook and in this embodiment, a star ornament (1) for example. Bulbs (2) are mounted on the star ornament (1). The character of the present invention is in that a lot of shining pieces (3) are also provided on the ornament (1). Each shining piece (3) has a central hole (31) for being placed around a related bulb (2). Connecting rods (4), each of which has a ball head (41), are provided beside the bulbs (2). Each shining piece (3) has an aperture (32), which receives a related connecting rod (4) on the ornament (1). Hence, the shining piece (3) is kept on the bulb (2) and the ornament (1) and is swingable.

Accordingly, the ornament (1) of the present invention has many bulbs (2), which emit rays outward directly and the shining pieces (5) can then reflect rays of the bulb (2) at the same time. The ornament connected the swingable shining pieces of the present invention can thus display a better lighting effect. Accompanying with the swingable pieces, the patterned ornament can obtain a best shining decorative effect without increasing use of bulbs.

Hence, the present invention obtains improved utilization and should be allowed for a patent.

1. An ornament having swingable shining pieces including a plurality of bulbs connected on the ornament, the ornament having a rigid body, a character is in that a plurality of shining pieces being provided on the ornament, the plurality of shining pieces move in a vertical direction, wherein each shining piece has a central hole for being placed around a related bulb, and connecting rods, each of which has a ball head, being formed beside the bulbs to engage a related shining piece in order that the shining piece is swingable.

2. The ornament having swingable shining structures as claimed in claim 1, wherein the configuration of the ornaments are interchangeable.
